(19) United States
(12) Patent Application Publication
(10) Pub. No.: US 2007/0090685 A1
(43) Pub. Date: Apr. 26, 2007

(54) WHEEL FOR MOTORCYCLE AND PRODUCTION METHOD THEREOF

(75) Inventors: Takuro Sekiguchi, Shizuoka-ken (JP); Masashi Kataoka, Shizuoka-ken (JP)

Correspondence Address: KNOBBE MARTENS OLSON & BEAR LLP, 2040 MAIN STREET, FOURTEENTH FLOOR, IRVINE, CA, 92614, US

(73) Assignee: YAMAHA HATSUDOKI KABUSHIKI KAISHA, Shizuoka-ken (JP)

(21) Appl. No.: 11/552,483

(22) Filed: Oct. 24, 2006

(30) Foreign Application Priority Data
Oct. 26, 2005 (JP) 2005-311274

(51) Int. Cl. B60B 3/10

(52) U.S. Cl. 301/64.101

(57) ABSTRACT

A wheel for a motorcycle comprising a rim section to which a tire is mounted, a hub section including an outer tubular section and an inner tubular section, and a plurality of spoke sections connecting the rim section and the hub section to each other. The hub section is configured to reduce machining steps during manufacture.

### CROSS-REFERENCE TO RELATED APPLICATIONS

This application claims the priority benefit of Japanese Patent Application No. 2005-311274, filed Oct. 26, 2005, which is hereby incorporated by reference in its entirety.

### BACKGROUND OF THE INVENTION

1. Field of the Invention

The present invention generally relates to a motorcycle wheel and a method of producing the wheel. More particularly, the wheel comprises a hub having an outer tubular section and an inner tubular section formed in a manner to reduce material and manufacturing steps.

2. Description of the Related Art

A motorcycle wheel is disclosed in Japanese Patent Document JP-A-2000-280702. As shown in FIG. 13 of the present application, the motorcycle wheel 100 is formed with a rim section 101 to which a tire is mounted, a hub section 102 through which an axle extends, and a plurality of spoke sections 103 connecting the rim section 101 and the hub section 102. The hub section 102 is formed with an inner tubular section 110, an outer tubular section 111, and a connecting part 112 that connects the inner and outer tubular sections. The hub section 102 further includes a space 113 that is defined between the inner tubular section 110 and the outer tubular section 111. The space 113 may result in a weight savings. Bearing support surfaces 110a, 110b are formed on both sides of an inner circumferential surface of the inner tubular section 110. The bearing support surfaces 110a, 110b are formed by machining after the wheel 100 is cast.

With reference to FIG. 13, a portion of the inner tubular section 110 is formed as a separate member that partially defines the space 113 between the inner tubular section 110 and the outer tubular section 111. The separate member sometimes is referred to as an auxiliary tubular member 114. However, because the auxiliary tubular member 114 needs to be disposed within a mold or a core that is used to define the space 113, the casting process becomes more difficult.

FIG. 14 shows another configuration of a motorcycle wheel. As shown, a hub section 121 of a wheel 120 is constructed with an outer tubular section 122 formed in the wheel. The wheel 120 further includes a first inner tubular section 123 formed in the wheel and a second inner tubular section 131 formed at a damper housing 130. Bearing support surfaces 123a, 131a are formed at respective inner circumferential surfaces of the pair of inner tubular sections 123, 131.

Because a space 140 is defined between the inner tubular sections 121, 131 and the outer tubular section 122 of the hub section 121 in FIG. 14, an achieved weight reduction can be similar to the configuration of FIG. 13. Also, because neither an auxiliary tubular section nor a core need to be placed within a mold in the casting process of the wheel 120, the casting process is not as difficult when compared to the configuration of FIG. 13.

The wheel 120 of FIG. 14, however, requires a machining process to form bolt holes 124 used to attach a damper housing 130. The bolt holes must be machined after the casting process. The damper housing 130 is then assembled after the machining process. After the assembly of the damper housing 130, two bearing support surfaces 123a, 131a are machined in respective inner circumferential surfaces of the inner tubular section 123 of the wheel 120 and the inner tubular section 131 of the damper housing 130. Additionally, if the inner circumferential surfaces of the respective inner tubular sections 123, 131 are machined to form the pair of bearing support surfaces before the wheel 120 and the damper housing 130 are assembled together, accurate positioning will likely not be achieved.

### SUMMARY OF THE INVENTION

Because of the reasons discussed above, the latter conventional art requires machining to the wheel to be done after assembly. Thus production time and difficulty are unnecessarily increased. Thus a need exists to provide a wheel of a motorcycle that can simplify production.

Accordingly, one aspect of an embodiment of the present invention involves a wheel for a motorcycle. The wheel comprises a rim section to which a tire is mounted, a hub section and a plurality of spoke sections. The hub section comprises an outer tubular section and an inner tubular section. The inner tubular section and the outer tubular section each comprise a first lateral end opening and a second lateral end opening. An axle extends through the hub section. A plurality of spoke sections connects the rim section and the hub section to each other. A damper housing attaching section is formed along a portion of the outer tubular section of the hub section. A bearing support surface is formed along an inner circumferential surface of the inner tubular section of the hub section.

Another aspect of an embodiment of the present invention involves a production method for a motorcycle wheel. The method comprises forming a wheel cast body by die-casting a rim section, a hub section comprising an inner tubular section and an outer tubular section, and a plurality of spoke sections. The method also comprises machining a damper housing attaching section on the outer tubular section of the hub section of the wheel cast body, and machining a pair of bearing support surfaces on an inner circumferential surface of both ends of the inner tubular section of the hub section.

A further aspect of an embodiment of the present invention involves a wheel for a motorcycle comprising a rim section to which a tire is mounted, a hub section and a plurality of spoke sections connecting the rim section and the hub section. Each of the spoke sections comprises an H shape and the H shape comprises a first rib and a second rib. The first rib comprises a generally planar outward facing surface and the second rib comprises a second generally planar outward facing surface.

An aspect of an embodiment of the present invention also involves a method for manufacturing a wheel for a motorcycle. The method comprises die casting, using a plurality of dies, a rim section to which a tire can be mounted, a hub section through which an axle can extend, and a plurality of spoke sections connecting the rim section and the hub section. The spoke sections comprise an H shape and the H shape comprising a first rib and a second rib. The first rib comprises a first generally planar outward facing surface and the second rib comprises a second generally planar outward facing surface. The method also comprises separating at least two of the dies along a parting surface with the parting surface passing along a first distal tip of the first rib and a second distal tip of the second rib. The first distal tip and the second distal tip are located on a common side of the wheel.

### BRIEF DESCRIPTION OF THE DRAWINGS

These and other features, aspects and advantages will now be described with reference to drawings of a preferred embodiment. The drawings comprise the following figures.

FIG. 1 shows a side elevation view of a motorcycle.

FIG. 2 shows a right side elevation view of an embodiment of a wheel that is arranged and configured in accordance with certain features, aspects and advantage of the present invention.

FIG. 3 shows a left side elevation view of the rear wheel of FIG. 2.

FIG. 4 shows a cross sectional view taken along the line A-A of FIG. 2.

FIG. 5 shows a right side elevation view of a wheel body of the wheel of FIG. 2.

FIG. 6 shows a left side elevation view of the wheel body of FIG. 5.

FIG. 7 shows a cross sectional view taken along the line B-B of FIG. 5.

FIG. 8 shows a cross sectional view taken along the line C-C of FIG. 7.

FIG. 9 shows a cross sectional view used to explain a casting process.

FIG. 10(a) is a cross sectional view showing a position of a parting surface of a cast metal mold.

FIG. 10(b) is a cross sectional view showing an example in which the parting surface is positioned in the center in a width direction of the wheel body.

FIG. 11 shows a cross sectional view for explaining a machining process to the wheel body.

FIG. 12 shows a cross sectional view for explaining a process in which a damper housing is assembled to the wheel body.

FIG. 13 is a cross sectional view of a conventional wheel body.

FIG. 14 is a cross sectional view of another conventional wheel body and a damper housing.

### DETAILED DESCRIPTION OF THE PREFERRED EMBODIMENT

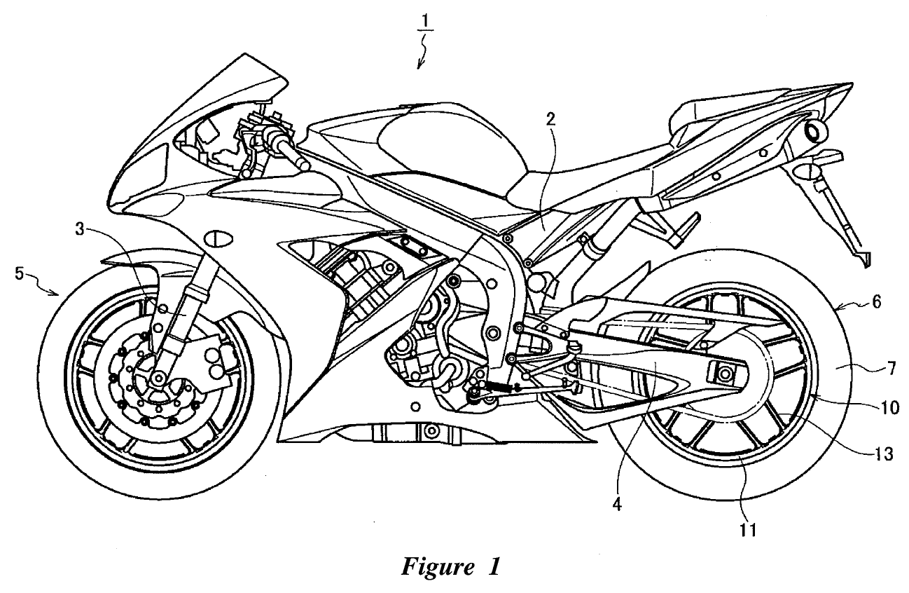

As shown in FIG. 1, the motorcycle 1 includes a vehicle body 2, a front fork 3 supported at a front position of the vehicle body, and a rear arm 4 supported at a rear position of the vehicle body 2. The motorcycle 1 also includes a front wheel 5 and a rear wheel 6 which are supported at respective distal ends of the front fork 3 and the rear arm 4. The rear wheel 6 further comprises a wheel body 10, which will be discussed in greater detail below.

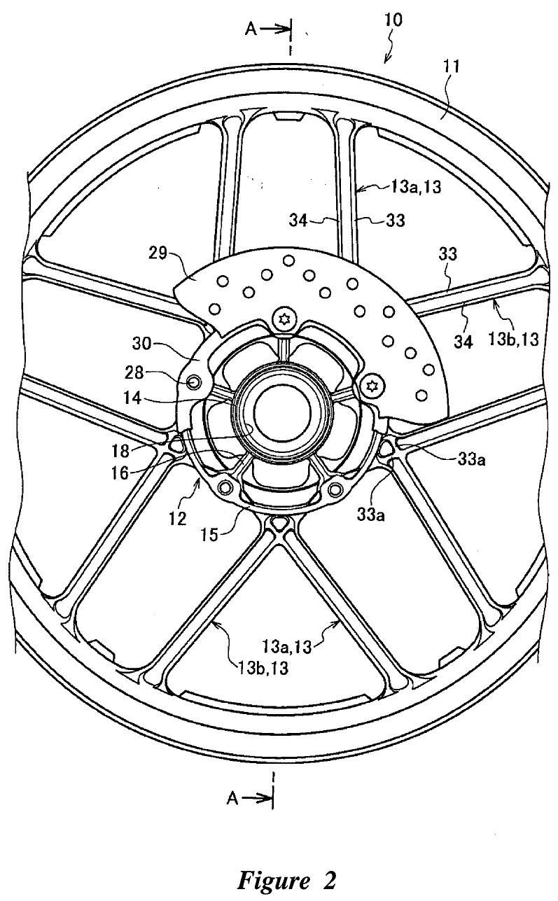

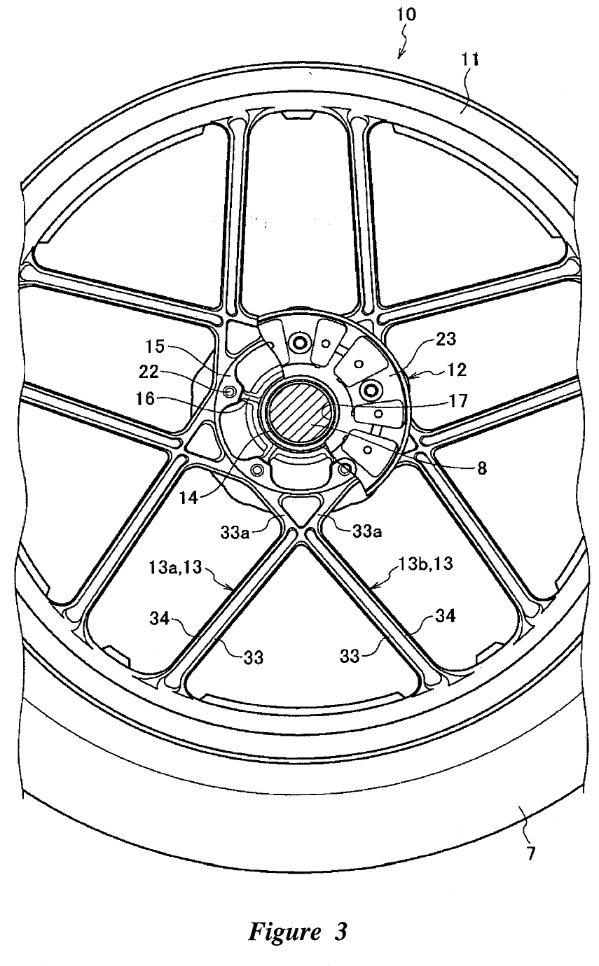

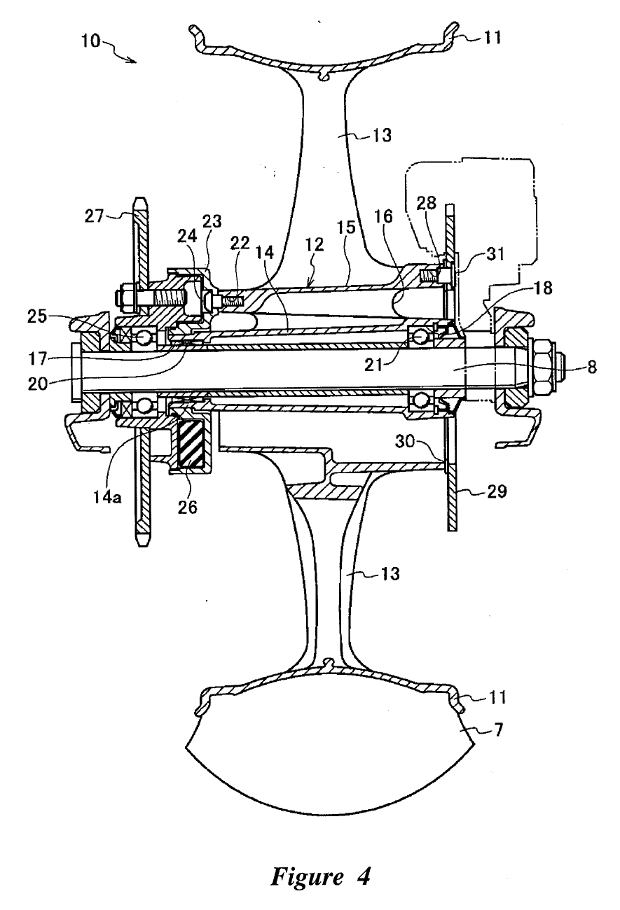

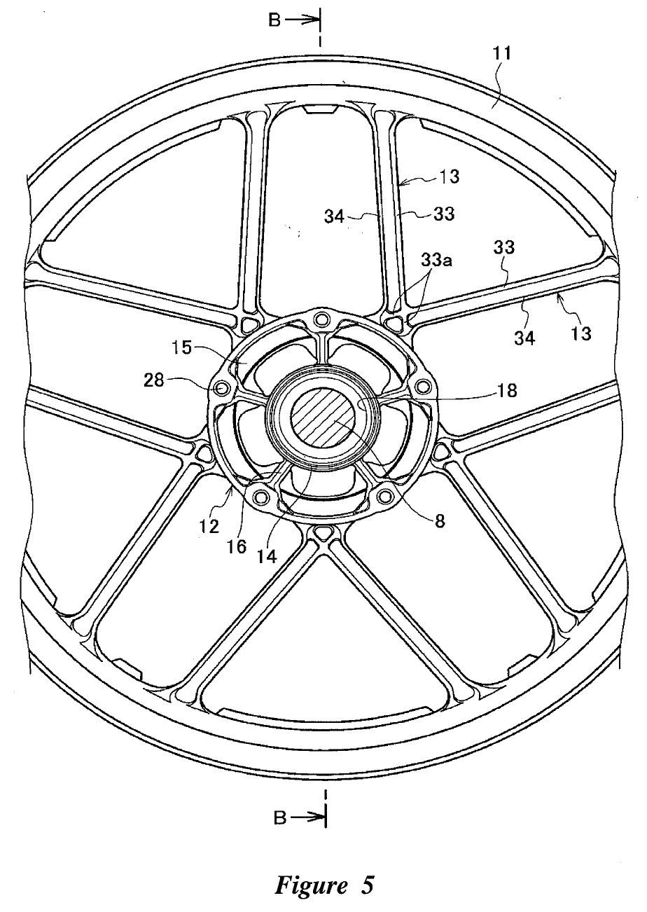

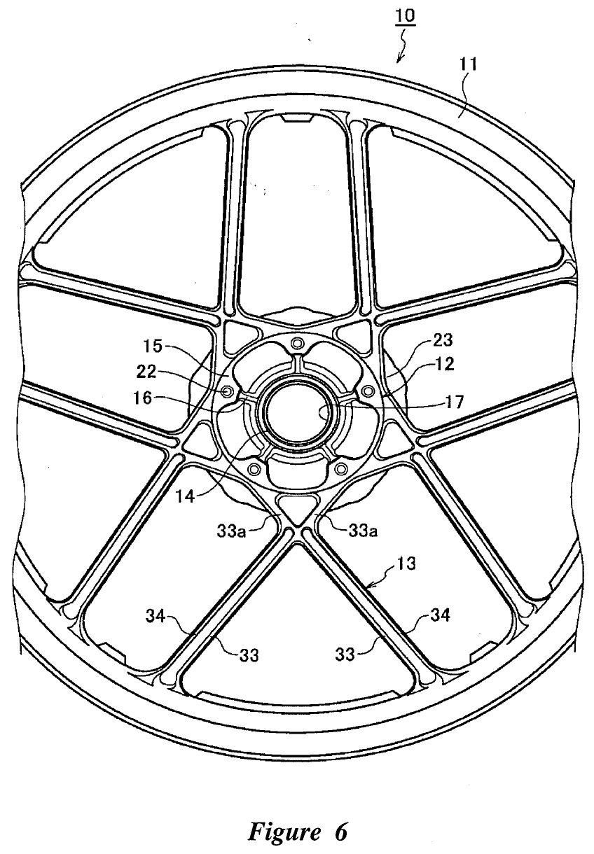

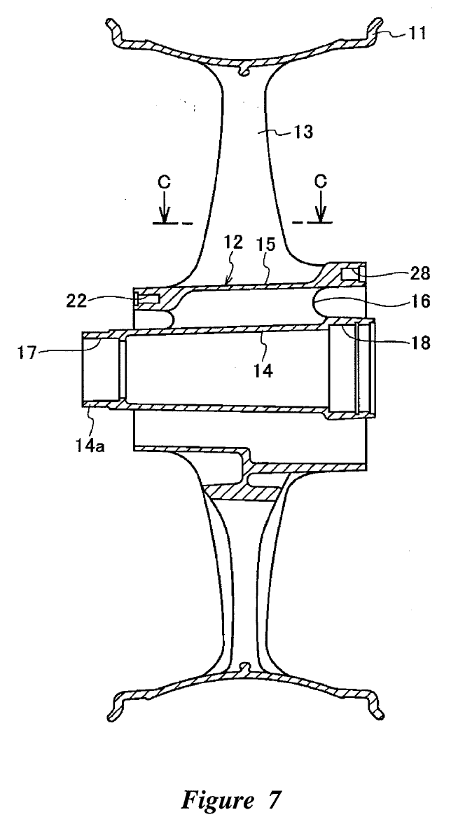

The wheel body 10 of the rear wheel 6 is preferably made by CF die-casting using a magnesium material. One advantage of using magnesium is that the wheel 10 can be produced to have a high strength and a low weight as compared to aluminum or steel. Other casting techniques and materials also can be used. As shown in FIGS. 2-7, a tire 7 is mounted on the wheel body 10. The wheel body 10 comprises an annular rim section 11 and a hub section 12 through which an axle 8 extends. The illustrated wheel body also comprises ten spoke sections 13 that interconnect the rim section 11 and the hub section 12.

The hub section 12 preferably is constructed with an inner tubular section 14, an outer tubular section 15, and a connecting section 16. The connecting section 16 connects sections 14, 15. The inner tubular section 14 and the outer tubular section 15 have inclining tubular configurations that incline together in the same direction. In other words, the sections 14, 15 preferably define a frustum or a conical configuration. The conical portions more preferably are arranged such that the surfaces of the inner conical section 14 and the outer conical section are substantially parallel.

Both the inner tubular section 14 and the outer tubular section 15 preferably are generally axially aligned with axle 8. The inner and outer circumferential surfaces advantageously define a certain draft angle (approximately 1.5 degrees). That is, the inner and outer circumferential surfaces of the inner tubular section 14 and the outer tubular section 15 both extend at an angle relative to a cylinder by a draft angle of approximately 1.5 degrees. Thus, by virtue of the draft angle, the inner tubular section 14 and the outer tubular section 15 are formed in such a manner that an opening area of one lateral side is larger than an opening area of the other lateral side.

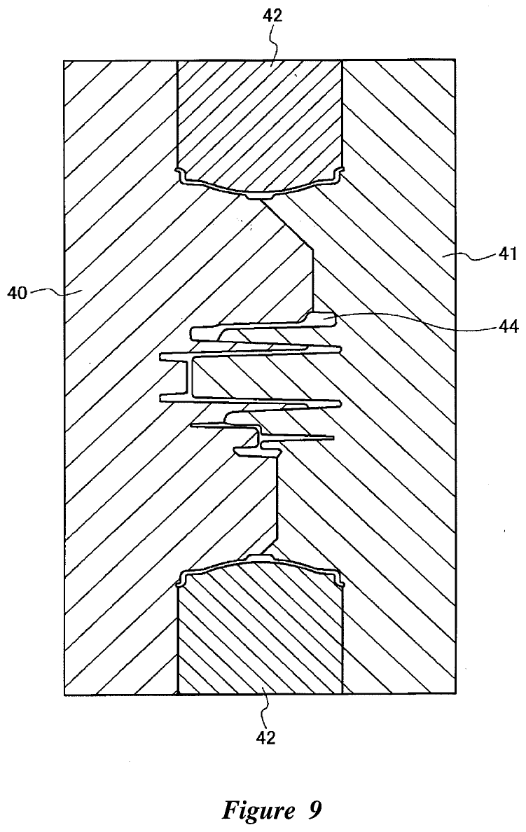

The hub section 12 preferably comprises the inner tubular section 14 and the outer tubular section 15 that more preferably define a draft angle. This geometry yields a hub section 12 that can be produced by die-casting because of including sufficient draft angles. Thus, the slightly conical shape is advantageous in that casting molds 40 and 41 of FIG. 9 are more easily released when the wheel 10 has solidified and is to be removed from the mold. Moreover, due to the frustum-shaped geometry, the material existing between the inner tubular section 14 and the outer tubular section 15 can be effectively reduced. In other words, the slightly conical shape helps when casting the hub section 12 so as to allow less material to be used in the casting process.

The inner circumferential surfaces on the ends of the inner tubular section 14 are formed as a pair of bearing support surfaces 17, 18. A needle bearing 20 can be located between one bearing support surface 17 and the axle 8, while a ball bearing 21 can be located between the bearing support surface 18 and the axle 8. The wheel body 10 is supported for rotation by the axle 8 via the needle bearing 20 and the ball bearing 21.

Several bolt holes 22 are formed at one end of the outer tubular section 15 and are provided to attach a damper housing 23 to the wheel 10. Also, a projection 14a that extends axially beyond an end of the outer tubular section 15 is formed at one end of the inner tubular section 14. The projection 14a supports the damper housing 23, which is fixed to the tubular section 15 by a plurality of bolts 24. The bolts 24, or other fasteners, can be connected to the tubular section 15 at the holes 22. The damper housing 23 is fitted on the projection of the inner tubular section 14 of the hub section 12. This eases the positioning and installation of the damper body 23 on the wheel 10.

A ball bearing 25 can be located between the damper housing 23 and the axle 8 so that the damper housing 23, together with the wheel body 10, is supported for rotation about the axle 8 via the ball bearing 25. Multiple dampers 26 are supported at spaced intervals inside the damper housing 23 and transmit torque from a sprocket 27 to the wheel body 10.

Several bolt holes 28 are formed on the other side of the outer tubular section 15 and are provided to attach a brake disk to the wheel 10. The brake disk 29 is coupled to the outer tubular section 15 by a plurality of bolts 31 and a ring shaped aluminum plate 30 is provided between the brake disk 29 and the outer tubular section 15. The aluminum plate helps in produce a flat mounting surface for the brake disk 29, which in turn helps to assure that the brake disk 29 spins true after assembly. The aluminum plate also is advantageous in that it helps to prevent corrosion due to electrolysis, or electrical corrosion. Moreover, the aluminum plate helps to dissipate heat, which may be produced while braking, away from the brake disk 29.

With reference to FIGS. 2-3, 5-6, and 8, each spoke section 13 preferably extends from the hub section 12 to the rim section 11 in a tangential direction. Because the spoke sections 13 extend in tangential directions to the hub section 12, the bending stress on the spoke sections 13 is highly reduced. Thus, acceleration and braking forces produce generally compressive and tensile stresses on the spokes 13. Furthermore, the shape and orientation of the spokes 13 reduces stress concentrations in the wheel 10 and reduces the weight of the wheel 10 because less oversizing is required to support the loads.

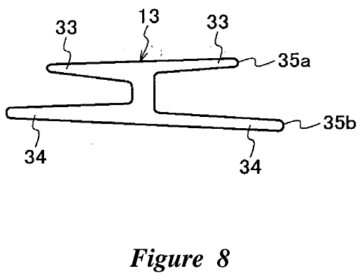

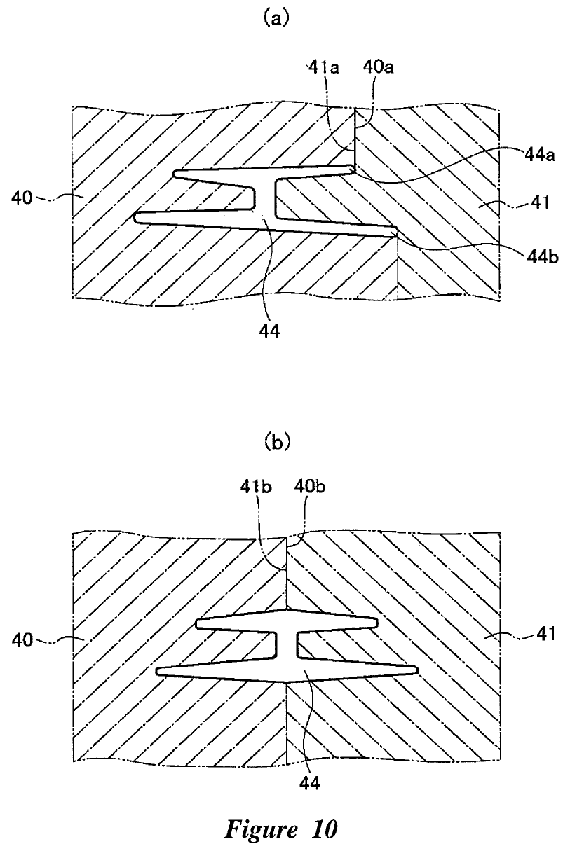

As shown in FIG. 8, a cross sectional surface of each spoke section 13 can be formed as an H-shape. In the illustrated configuration, the H-shape defines a pair of ribs 33, 34 that are formed on the front and rear side sides of each of the spokes 13. The ribs 33, 34 are advantageous in that the H shape adds to the strength of the spoke 13. When casting this shape, parting surfaces 40b, 41b of a mold can be located at the distal end portions 35a, 35b of the respective ribs 33, 34. That is, as shown in FIG. 10(a), right and left molds 40, 41 for forming the spoke section 13 have the parting surfaces 40a, 41b located at cavities 44a, 44b that form the distal end portions 35a, 35b of the respective ribs 33, 34. It is also preferable that the ribs 33, 34 are positioned to be farthest apart at the distal tips 35a and 35b. Thus, the right half of the H-shape can be formed to comprise a generally uniform rib thickness.

The design of FIG. 10a differs from FIG. 10b in that the ribs of the spoke in FIG. 10b are formed with molds 40 and 41 that part along a center portion of the spoke. This parting configuration yields a spoke that includes ribs that taper with decreasing thickness from the center of the ribs to the distal tips. The taper is desired to allow the mold to be separated from the formed wheel. Due to this tapering, the spoke ribs do not have a constant thickness. Because of the reasons above, by positioning the parting surfaces of the mold at the distal end portions 35a, 35b of the respective ribs 33, 34, the amount of material can be reduced and a lighter weight spoke 13 can be produced.

Neighboring spoke sections 13a, 13b merge together at connecting portions before connecting to the hub section 12. In other words, the illustrated two spoke sections 13a, 13b cross each other at a connection portion, which is located near the hub. After the connecting portion, the ribs 33 continue as ribs 33a and the ribs 33a connect to the hub portion 12. Thus, the ribs 33a preferably extend between the hub section 12 and the connecting portions. The illustrated crossing spoke configuration results in a very light weight and strong spoke assembly which results in an overall strong a light weigh wheel.

Next, production processes of the wheel body 10 will be described. First, a wheel cast body having a basic configuration of the wheel body 10 is formed by the CF die-casting method. As shown in FIG. 9, right and left molds 40, 41 and circumference molds 42, can be divided into four parts in the circumferential direction. The interior of a cavity 44 defined by the molds preferably is evacuated to facilitate being filled with molten magnesium. After the cavity is filled with the molten magnesium, the magnesium is cooled to a preset temperature to be solidified, resulting in a raw wheel body. Next, the right and left molds 40, 41 and the circumference molds 42 are removed.

In one embodiment, as shown in FIG. 10(a), portions of the right and left molds 40 and 41 for forming the spoke sections 13 are configured to have parting surfaces 40a, 41a that are offset to one side of a center plane of the wheel. In the illustrated embodiment, the parting surfaces 40a, 41a part at cavities 44a44b that correspond to distal end portions 35a, 35b of the respective ribs 33, 34 which generally form the H-shape of spokes 13.

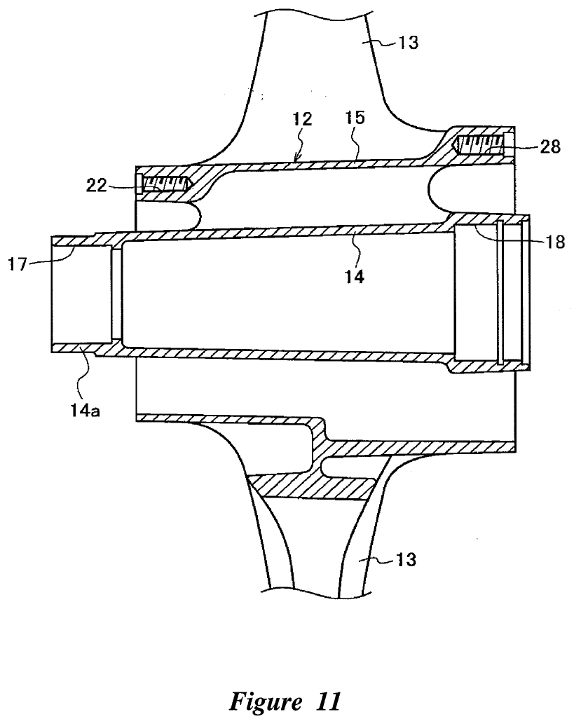

Next, the wheel cast body can be machined. As shown in FIG. 11, flats can be machined on both of end surfaces of the outer tubular section 15 of the hub section 12, and the bolt holes 22, 28 can be formed in desired locations in both of the end surfaces. Also, the inner surfaces on both sides of the inner tubular section 14 can be machined to create the bearing support surfaces 17, 18.

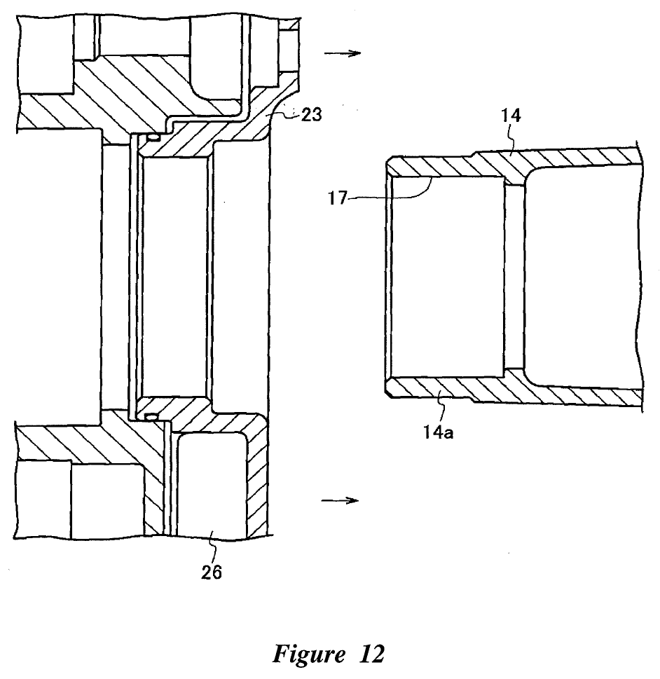

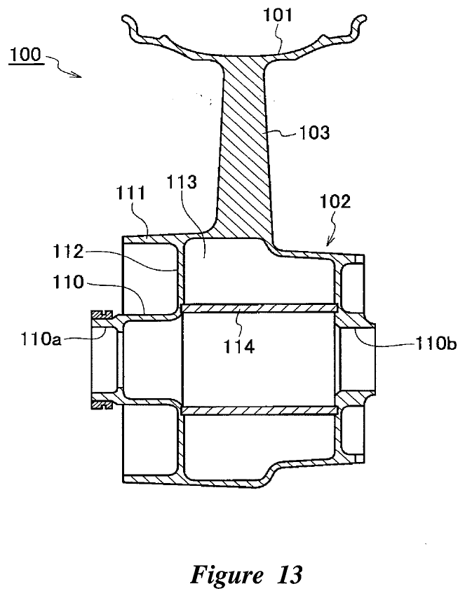

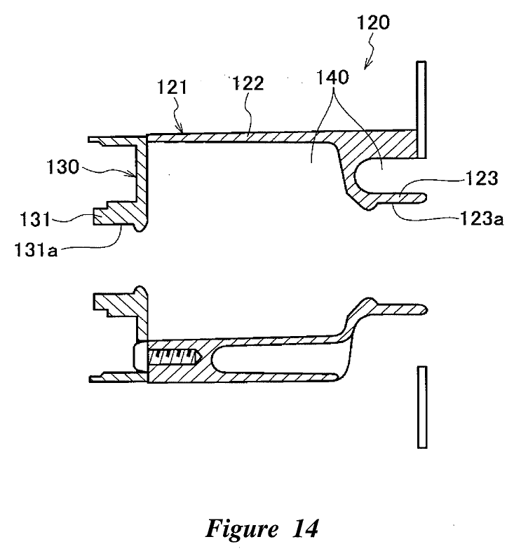

Next, respective components can be assembled with the wheel body 10. As shown in FIG. 12, the damper housing 23 is fitted on the side of the inner tubular section 14 that includes the extension 14a. The damper housing 23 is secured to the tubular section 15 by bolts 24. Also, the brake disk 29 is attached to the other side of the hub section 12, on top of the aluminum plate 30. The brake disk 29 and the aluminum plate 30 are fixed in place by the bolts 31.

As previously described, the wheel body 10 comprises the bolt holes 22 that are formed in the tubular section 15 and support the bolts 24 which attach the damper housing 23. The tubular section 14 further includes the pair of bearing support surfaces 17, 18 that are formed in the inner tubular section 14 of the hub section. Thus, the machining processes that are needed to complete the wheel are preferably reduced. In other words, the machining processes for the wheel cast body can be performed in one in setting, prior to any assembling processes and the production simplicity thus can be improved.

The wheel body 10 is preferably formed by a casting process in which the rim section 11, the hub section 12, including the inner tubular section 14 and the outer tubular section 15, and a plurality of spoke sections 13 are cast by die-casting to obtain a wheel cast body. The wheel 10 is further processed by a machining process in which the bolt holes 22 are formed on the outer tubular section 15 of the hub section 12 of the wheel cast body, and a pair of bearing support surfaces 17, 18 are formed on both sides of the inner surfaces of the inner tubular section 14 of the hub section 12. Thus, the machining processes preferably are all performed together and a second set of machining processes are not required after assembly has occurred. By providing a wheel 10 in which substantially all machining can be performed at one time, the production time can be greatly reduced.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

What is claimed is:

1. A wheel for a motorcycle, the wheel comprising a rim section to which a tire is mounted, a hub section comprising an outer tubular section and an inner tubular section, said inner tubular section and said outer tubular section each comprising a first lateral end opening and a second lateral end opening, an axle extending through said hub section, a plurality of spoke sections connecting said rim section and said hub section to each other, a damper housing attaching section being formed along a portion of said outer tubular section of said hub section, and a bearing support surface being formed along an inner circumferential surface of said inner tubular section of said hub section.

2. The wheel according to claim 1, wherein said inner tubular section of said hub section comprises a projection that extends beyond an end of said outer tubular section in an axial direction, and a damper housing being fitted on said projection and being secured to said damper housing attaching section.

3. The wheel according to claim 2, wherein the damper housing encloses a damper that attenuates a drive force transmitted from an engine to the wheel.

4. The wheel according to claim 1, wherein an area defined by the first lateral end opening of each of the inner tubular section and the outer tubular end section is larger than an area defined by the respective second lateral end opening of each of the inner tubular section and the outer tubular section.

5. The wheel according to claim 1, each of the spoke sections comprises a rib.

6. The wheel according to claim 5, wherein said rib is formed at a leading edge portion of each of said spoke sections and at a trailing edge portion of the each of said spoke sections relative to a rotational direction of the wheel.

7. The wheel according to claim 5, wherein said plurality of spoke sections comprises a first spoke section and a second spoke section positioned next to each other, said first and second spoke sections connected to said hub and said rim while intersection between said hub and said rim.

8. The wheel according to claim 7, wherein said first spoke section and said second spoke section intersect each other at a location closer to said hub than said rim.

9. The wheel according to claim 1, wherein each of said spoke sections extends generally tangentially from said outer tubular section of said hub section.

10. The wheel according to claim 1, wherein the wheel is formed of magnesium.

11. The wheel according to claim 10 further comprising a brake disk, wherein said brake disk is assembled with an end of said outer tubular section via an aluminum plate.

12. A production method of a motorcycle wheel, the method comprising:
forming a wheel cast body by die-casting a rim section, a hub section comprising an inner tubular section and an outer tubular section, and a plurality of spoke sections; and
machining a damper housing attaching section on said outer tubular section of said hub section of said wheel cast body, and machining a pair of bearing support surfaces on an inner circumferential surface of both ends of said inner tubular section of said hub section.

13. The method of claim 12, wherein each of said spoke sections comprises a rib that is formed at a leading edge portion and at a trailing edge portion of said spoke section relative to a rotational direction of the wheel, and a parting surface is defined at a distal end portion of each said rib.

14. A wheel for a motorcycle comprising:
a rim section to which a tire is mounted;
a hub section
a plurality of spoke sections connecting said rim section and said hub section, each of said spoke sections comprising an H shape and said H shape comprising a first rib and a second rib, said first rib comprising a generally planar outward facing surface and said second rib comprising a second generally planar outward facing surface.

15. The wheel of claim 14, wherein at least a substantial portion of a thickness of said first rib and of said second rib is uniform.

16. A method for manufacturing a wheel for a motorcycle comprising:
die casting, using a plurality of dies, a rim section to which a tire can be mounted, a hub section through which an axle can extend, and a plurality of spoke sections connecting said rim section and said hub section, said spoke sections comprising an H shape and said H shape comprising a first rib and a second rib, said first rib comprising a first generally planar outward facing surface and said second rib comprising a second generally planar outward facing surface;
separating at least two of said dies along a parting surface, said parting surface passing along a first distal tip of said first rib and a second distal tip of said second rib, and said first dist tip and said second distal tip being located on a common side of said wheel.

17. The method of claim 16, further comprising a machining process in which a damper housing attaching section is formed on an outer tubular section of said hub section, and a bearing support surface is formed on each end of an inner circumferential surface of an inner tubular section of said hub section.

18. The method of claim 16, further comprising attaching a damper housing to said hub section.

19. The method of claim 16, further comprising attaching a brake disk to said hub section.
